(19) United States
(12) Patent Application Publication
(10) Pub. No.: US 2026/0169941 A1
(43) Pub. Date: Jun. 18, 2026

(54) SWITCHING DEVICE, MEMORY EXPANSION MODULE, AND MEMORY EXPANSION SYSTEM

(71) Applicant: SUZHOU METABRAIN INTELLIGENT TECHNOLOGY CO., LTD., Suzhou, Jiangsu (CN)

(72) Inventor: Tao ZHANG, Suzhou, Jiangsu (CN)

(21) Appl. No.: 19/116,256

(22) PCT Filed: Aug. 5, 2024
(86) PCT No.: PCT/CN2024/109894

§ 371 Date: Mar. 27, 2025

(30) Foreign Application Priority Data
Sep. 6, 2023 (CN) 202311144716.4

(51) Int. Cl. G06F 13/40; G06F 13/38; G06F 13/42

(52) U.S. Cl. CPC G06F 13/4022; G06F 13/382; G06F 13/4221

(57) ABSTRACT

The embodiments of the present disclosure provides a switching device, a memory expansion module and a memory expansion system, wherein the switching device includes a connector and a controller, wherein, the connector is deployed with M uplink ports and N downlink ports, wherein M is an integer greater than or equal to 1 and N is an integer greater than 1; the M uplink ports are configured to connect to a host end by a CXL (Compute Express Link) protocol; the N downlink ports are configured to connect to a memory end by the CXL protocol, wherein the memory end is an extended memory of the host end; the controller is configured to control a binding between the M uplink ports and the N downlink ports, wherein each uplink port is allowed to be mapped to the N downlink ports. By the present disclosure, the problem of low memory capacity can be solved, and the effect of expanding the memory capacity can be achieved.

### CROSS-REFERENCE TO RELATED APPLICATION

The present disclosure claims the priority of Chinese patent application filed in CNIPA on Sep. 6, 2023, with the application number of 202311144716.4 and the application name of “SWITCHING DEVICE, MEMORY EXPANSION MODULE, AND MEMORY EXPANSION SYSTEM”, the entire contents of which are incorporated into the present disclosure by reference.

### FIELD

The embodiments of the present disclosure relates to the field of computers, in particular to a switching device, a memory expansion module and a memory expansion system.

### BACKGROUND

In recent years, great progress has been made in artificial intelligence, deep learning and high-performance computing. More and more data are generated by a CPU (Central Processing Unit), a GPU (Graphics Processing Unit) and other artificial intelligence processors. They need to be seamlessly exchanged among processors to execute extremely dense neural network computing algorithms and complete key tasks such as data mining, vision and voice processing.

At present, the memory system capacity for data exchange between processors lags far behind the memory capacity required for data processing.

Aiming at the problem of low memory capacity in related art, no effective solution has been put forward.

### SUMMARY

The embodiments of the present disclosure provide a switching device, a memory expansion module and a memory expansion system, to at least solve the problem of low memory capacity in the related art.

According to a first aspect, provided with a switching device, including a connector and a controller, wherein, the connector is deployed with M uplink ports and N downlink ports, wherein M is an integer greater than or equal to 1 and N is an integer greater than 1; the M uplink ports are configured to connect to a host end by a CXL (Compute Express Link) protocol; the N downlink ports are configured to connect to a memory end by the CXL protocol, wherein the memory end is an extended memory of the host end; the controller is configured to control a binding between the M uplink ports and the N downlink ports, wherein each uplink port is allowed to be mapped to the N downlink ports.

In one exemplary embodiment, the controller is configured to: acquire a target mapping relationship between a target uplink port and a target downlink port; bind the target uplink port and the target downlink port according to the target mapping relationship.

In one exemplary embodiment, the switching device further includes a target processor, wherein, the controller includes a fabric manager module and an in-band configuration port; the target processor is configured to send a target control signal to the fabric manager module through the in-band configuration port; the fabric manager module is configured to find the target mapping relationship corresponding to the target control signal from the control signals and mapping relationships with corresponding relationships and bind the target uplink port and the target downlink port according to the target mapping relationship.

In one exemplary embodiment, both the target processor and the controller are deployed with universal asynchronous transceiver interfaces, wherein, the target processor is configured to write the control signals and the mapping relationships with corresponding relationships into the controller at an initialization stage of the switching device.

In one exemplary embodiment, both the target processor and the controller are deployed with universal asynchronous transceiver interfaces, and in the initialization stage of the switching device, the controller receives signals sent by the target processor through the universal asynchronous transceiver interfaces, to configure types of the uplink ports and downlink ports of the switching device; the target processor writes the control signals and the mapping relationships with corresponding relationships into the controller through the universal asynchronous transceiver interface, and the controller receives and stores the corresponding relationships between the control signals and the mapping relationships, wherein the mapping relationships include the corresponding relationships between the uplink ports and the downlink ports.

In one exemplary embodiment, the target uplink port includes m uplink ports and the target downlink port includes n downlink ports, wherein m is less than or equal to M and n is less than or equal to N.

In one exemplary embodiment, the M uplink ports include a first uplink port, a second uplink port, a third uplink port and a fourth uplink port, and the host end includes a first processor and a second processor, wherein, the first uplink port and the second uplink port are both connected to the first processor, and the third uplink port and the fourth uplink port are both connected to the second processor.

In one exemplary embodiment, the N downlink ports include a first downlink port and a second downlink port, and the memory end includes a first memory unit and a second memory unit, wherein, the first downlink port is connected to a memory expansion controller in the first memory unit, and the second downlink port is connected to a memory expansion controller in the second memory unit.

In one exemplary embodiment, the uplink port of the switching device is connected to the host end through the CXL protocol, and the host end includes a processor 0 and a processor 1, and the processor 0 and the processor 1 are interconnected through a UPI (Ultra Path Interconnect) bus to form a dual-path server as the host end, in response to that one processor performs memory expansion, the other processor obtains a expanded memory through the UPI (Ultra Path Interconnect) bus, and each processor provides two sets of CXL x16 interfaces, which are respectively connected to the uplink port of the switching device; the downlink port of the switching device is connected to the memory expansion controller at the memory end through the CXL protocol, enabling the memory expansion by a double-rate controller inside the memory expansion controller.

According to a second aspect, provided with a memory expansion module, including a switching device and a memory end, wherein, the switching device is deployed with M uplink ports and N downlink ports, and the N downlink ports are connected to the memory end through a CXL (Compute Express Link) protocol, wherein M is an integer greater than or equal to 1, and N is an integer greater than 1; the M uplink ports are configured to connect to the host end by the CXL protocol; the switching device is configured to control a binding between the M uplink ports and the N downlink ports, wherein each uplink port is allowed to be mapped to the N downlink ports; the memory end is configured to provide extended memory for the host end.

In one exemplary embodiment, the switching device includes a connector and a controller, wherein, the connector is deployed with the M uplink ports and the N downlink ports; the controller is configured to obtain a target mapping relationship between a target uplink port and a target downlink port; bind the target uplink port and the target downlink port according to the target mapping relationship.

In one exemplary embodiment, the switching device further includes a target processor, wherein, the controller includes a fabric manager module and an in-band configuration port; the target processor is configured to send a target control signal to the fabric manager module through the in-band configuration port; the fabric manager module is configured to find the target mapping relationship corresponding to the target control signal from the control signals and mapping relationships with corresponding relationships and bind the target uplink port and the target downlink port according to the target mapping relationship.

In one exemplary embodiment, both the target processor and the controller are deployed with universal asynchronous transceiver interfaces, wherein, the target processor is configured to write the control signals and the mapping relationships with corresponding relationships into the controller at an initialization stage of the switching device.

In one exemplary embodiment, the target uplink port includes m uplink ports and the target downlink port includes n downlink ports, wherein m is less than or equal to M and n is less than or equal to N.

In one exemplary embodiment, the M uplink ports include a first uplink port, a second uplink port, a third uplink port and a fourth uplink port, and the host end includes a first processor and a second processor, wherein, the first uplink port and the second uplink port are both connected to the first processor, and the third uplink port and the fourth uplink port are both connected to the second processor.

In one exemplary embodiment, the N downlink ports include a first downlink port and a second downlink port, and the memory end includes a first memory unit and a second memory unit, wherein, the first downlink port is connected to a memory expansion controller in the first memory unit, and the second downlink port is connected to a memory expansion controller in the second memory unit.

According to a third aspect, provided with a memory expansion system, including a host end, a switching device and a memory end, wherein, the switching device is deployed with M uplink ports and N downlink ports, wherein the N downlink ports are connected to the memory end through a CXL (Compute Express Link) protocol, and the M uplink ports are connected to the host end through the CXL protocol, wherein M is an integer greater than or equal to 1, and N is an integer greater than 1; the switching device is configured to control a binding between the M uplink ports and the N downlink ports, wherein each uplink port is allowed to be mapped to the N downlink ports; the memory end is configured to provide an extended memory for the host end; the host end is configured to use the memory end as the extended memory.

In one exemplary embodiment, the switching device includes a connector and a controller, wherein, the connector is deployed with the M uplink ports and the N downlink ports; the controller is configured to obtain a target mapping relationship between a target uplink port and a target downlink port; bind the target uplink port and the target downlink port according to the target mapping relationship.

In one exemplary embodiment, the switching device further includes a target processor, wherein, the controller includes a fabric manager module and an in-band configuration port; the target processor is configured to send a target control signal to the fabric manager module through the in-band configuration port; the fabric manager module is configured to find the target mapping relationship corresponding to the target control signal from the control signals and mapping relationships with corresponding relationships and bind the target uplink port and the target downlink port according to the target mapping relationship.

In one exemplary embodiment, both the target processor and the controller are deployed with universal asynchronous transceiver interfaces, wherein, the target processor is configured to write the control signals and the mapping relationships with corresponding relationships into the controller at an initialization stage of the switching device.

In one exemplary embodiment, the target uplink port includes m uplink ports and the target downlink port includes n downlink ports, wherein m is less than or equal to M and n is less than or equal to N.

In one exemplary embodiment, the M uplink ports include a first uplink port, a second uplink port, a third uplink port and a fourth uplink port, and the host end includes a first processor and a second processor, wherein, the first uplink port and the second uplink port are both connected to the first processor, and the third uplink port and the fourth uplink port are both connected to the second processor.

In one exemplary embodiment, the N downlink ports include a first downlink port and a second downlink port, and the memory end includes a first memory unit and a second memory unit, wherein, the first downlink port is connected to a memory expansion controller in the first memory unit, and the second downlink port is connected to a memory expansion controller in the second memory unit.

According to the present disclosure, the M uplink ports deployed on the connector are connected to the host ends through the CXL (Compute Express Link) protocol, and the N downlink ports deployed on the connector are connected to the memory ends through the CXL protocol. As the controller realizes the binding between the M uplink ports and the N downlink ports, each host end connected to the uplink ports can use the extended memory connected to the downlink ports which have a mapping relationship with it, to expand the memory for one or more host ends. Therefore, the problem of low memory capacity can be solved, and the effect of expanding the memory capacity can be achieved.

### BRIEF DESCRIPTION OF THE DRAWINGS

FIG. 1 is a schematic diagram one of a switching device according to an embodiment of the present disclosure;

FIG. 2 is a schematic diagram two of a switching device according to an embodiment of the present disclosure;

FIG. 3 is a schematic diagram three of a switching device according to an embodiment of the present disclosure;

FIG. 4 is a schematic diagram four of a switching device according to an embodiment of the present disclosure;

FIG. 5 is a schematic diagram five of a switching device according to an embodiment of the present disclosure;

FIG. 6 is a schematic diagram six of a switching device according to an embodiment of the present disclosure;

FIG. 7 is a schematic diagram of a use process of a switching device according to an embodiment of the present disclosure;

FIG. 8 is a schematic diagram of a memory expansion process of a switching device according to an embodiment of the present disclosure;

FIG. 9 is a schematic diagram of a memory expansion module according to an embodiment of the present disclosure;

FIG. 10 is a schematic diagram of an expanded memory of a memory expansion module according to an embodiment of the present disclosure;

FIG. 11 is a schematic diagram of a memory expansion system according to an embodiment of the present disclosure;

FIG. 12 is a schematic diagram of an expanded memory of a memory expansion system according to an embodiment of the present disclosure;

FIG. 13 is a schematic diagram of an extended memory of a large-scale memory expansion system according to an embodiment of the present disclosure.

### DETAILED DESCRIPTION

Hereinafter, embodiments of the present disclosure will be described in detail with reference to the drawings and in combination with the embodiments.

It should be noted that the terms “first” and “second” in the description and claims of the present disclosure and the above drawings are used to distinguish similar objects, and are not necessarily used to describe a specific order or sequence.

In this embodiment, a switching device is provided. FIG. 1 is a schematic diagram one of a switching device according to an embodiment of the present disclosure. As shown in FIG. 1, the switching device includes a connector 102 and a controller 104, wherein M uplink ports (106-1 to 106-M) and N downlink ports (108-1 to 108-N) are deployed on the connector 102, wherein M is an integer greater than or equal to 1, and N is an integer greater than 1. M uplink ports (106-1 to 106-M) are configured to connect to the host end 110 by a CXL protocol; N downlink ports (108-1 to 108-N) are configured to connect to the memory end 112 by the CXL protocol, wherein the memory end 112 is the extended memory of the host end 110; The controller 104 is configured to control a binding between the M uplink ports (106-1 to 106-M) and the N downlink ports (108-1 to 108-N), wherein each uplink port is allowed to be mapped to the N downlink ports.

Through the switching device, the M uplink ports deployed on the connector are connected to the host ends through the CXL protocol, and N downlink ports deployed on the connector are connected to the memory ends through the CXL protocol. As the controller realizes the binding between the M uplink ports and the N downlink ports, each host end connected to the uplink ports can use the extended memory connected to the downlink ports which have a mapping relationship with it, thus expanding the memory for one or more host ends. Therefore, the problem of low memory capacity can be solved and the effect of expanding the memory capacity can be achieved.

Optionally, in this embodiment, the switching device proposed in the present disclosure is allowed to be used in a variety of scenarios for memory expansion by the CXL protocol, including but not limited to: multi-scale data set processing, data center and cloud computing, machine learning, etc. Any server that allows the deployment of devices can use the switching device proposed in the present disclosure, and any scenario that needs memory expansion can use the switching device proposed in the present disclosure for memory expansion.

Optionally, in this embodiment, one or more uplink ports and a plurality of downlink ports are deployed in the connector, and the connector can be, but is not limited to, a switch, a bridge, an electronic device allowing the deployment of uplink ports and downlink ports, and the like.

Optionally, in this embodiment, the uplink port is connected to the host device at the host end, and the host device can be but not limited to include a single-path server composed of one CPU or a multi-path server composed of a plurality of CPUs, and the multi-path server can be but not limited to a dual-path server composed of CPU0 and CPU1 interconnected by a UPI (Ultra Path Interconnect) bus.

Optionally, in this embodiment, the uplink port is connected to the host device on the host end through the CXL (Compute Express Link) protocol, for example, each CPU supports two CXL interfaces (namely CXL x16 interfaces) with a bandwidth of x16, and the two CXL x16 interfaces of a single CPU are respectively connected to the two uplink ports (USP, UpStream Port) of the connector.

Optionally, in this embodiment, the memory end is the extended memory of the host end, which may include, but is not limited to, the extended memory space and the devices connecting the extended memory to the downlink port. The expanded memory space may include, but is not limited to, a DIMM (Dual Inline Memory Modules), a SODIMM (Small Outline Dual Inline Memory Module), a UDIMM (Unbuffered Dual InLine Memory Modules or unregistered Dual In-line Memory Modules), etc. Devices that connect the extended memory to the downlink port may include, but are not limited to, a MXC (Memory Expander Controller), a HBM (High Bandwidth Memory) expansion module, a HMC (Hybrid Memory Cube) expansion module, etc.

Optionally, in this embodiment, the controller may, but is not limited to, control the binding of M uplink ports and N downlink ports according to the corresponding relationship between uplink ports and downlink ports, for example, preset the corresponding relationship between the M uplink ports and the N downlink ports, and bind the M uplink ports and the N downlink ports according to the preset corresponding relationship. Or, according to the usage of the M uplink ports and the N downlink ports, dynamically determine the corresponding relationship between the M uplink ports and the N downlink ports, and bind the M uplink ports and the N downlink ports according to the currently determined corresponding relationship.

Optionally, in this embodiment, it may be, but not limited to, to bind the uplink port and the downlink port by connecting the uplink port and the downlink port, for example, to connect the uplink port and the downlink port to bind the uplink port and the downlink port. Or, the signal transmitted by the uplink port is transmitted to the corresponding downlink port to bind the uplink port and the downlink port.

Optionally, in this embodiment, all uplink ports are allowed to be mapped to N downlink ports, and for a single uplink port, it can be bound with one or more downlink ports, that is, for a single uplink port, it may be that, but is not limited to that, one or more extended memories connected to downlink ports can be used according to the memory requirement of the host end connected to the current uplink port. For example, when the memory requirement of the host connected to the current uplink port is large, multiple downlink ports can be connected, so that multiple extended memories connected can be used. Or, under the condition that the memory requirement of the host connected to the current uplink port is small or no, a number of the connected downlink ports is reduced, thereby reducing the number of the connected extended memory.

In an exemplary embodiment, the controller is configured to obtain a target mapping relationship between a target uplink port and a target downlink port; bind the target uplink port and the target downlink port according to the target mapping relationship.

Optionally, in this embodiment, the target mapping relationship can be, but is not limited to, predetermined, or changed in real time according to the requirement of the host connected to the uplink port for expanded memory, for example, obtaining the target downlink port with the target mapping relationship with the target uplink port from the predetermined mapping relationship, and binding the target uplink port and the target downlink port. Or, according to the requirement of the host connected to the uplink port for expanded memory, selecting some downlink ports from all downlink ports as target downlink ports, and binding the target uplink port and the target downlink port.

Optionally, in this embodiment, the target mapping relationship is used to indicate the binding relationship between the target uplink port and the target downlink port, which may include, but is not limited to, the binding relationship between a target uplink port and a target downlink port, and the binding relationship between a target uplink port and a plurality of target downlink ports.

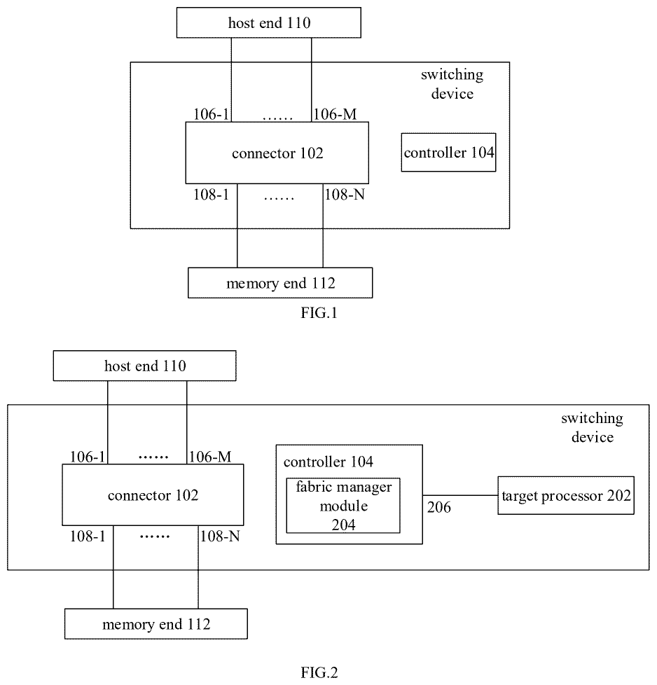

In an exemplary embodiment, FIG. 2 is a schematic diagram two of a switching device according to an embodiment of the present disclosure. As shown in FIG. 2, the switching device further includes a target processor 202, wherein the controller 104 includes a fabric manager module 204 and an in-band configuration port 206; The target processor 202 is configured to send a target control signal to the fabric manager module 204 through the in-band configuration port 206; The fabric manager module 204 is configured to find the target mapping relationship corresponding to the target control signal from the control signals and mapping relationships with corresponding relationships and bind the target uplink port and the target downlink port according to the target mapping relationship.

Optionally, in this embodiment, the fabric manager module of the controller is configured to control the binding between M uplink ports and N downlink ports, which may include, but is not limited to, a Fabric (in-band management controller), switches, routers, network management systems, etc.

Optionally, in this embodiment, the target processor sends a target control signal to the in-band configuration port, and the target processor may include, but is not limited to, a mCPU (micro Central Processing Unit). The in-band configuration port can be, but is not limited to, configured to forward the target control signal sent by the target processor to the fabric manager module, and the fabric manager module controls the binding of the target uplink port and the target downlink port according to the target control signal.

Optionally, in this embodiment, the in-band configuration port of the controller is configured to receive the target control signal sent by the target processor, the target control signal may include, but is not limited to, the target control signal carries the target mapping relationship between the target uplink port and the target downlink port, and the fabric manager module obtains the target mapping relationship between the target uplink port and the target downlink port by receiving the target control signal. Or, the target control signal carries information indicating the target mapping relationship between the target uplink port and the target downlink port, and the fabric manager module obtains the target mapping relationship between the target uplink port and the target downlink port by analyzing the information indicated by the target control signal.

Optionally, in this embodiment, the connection modes of the target processor and the in-band configuration port include: connection through a set of PCIe (Peripheral Component Interconnect Express, a high-speed serial computer expansion bus standard), connection through a PCI (Peripheral Component Interconnect, a high-speed serial computer expansion bus standard), and the like.

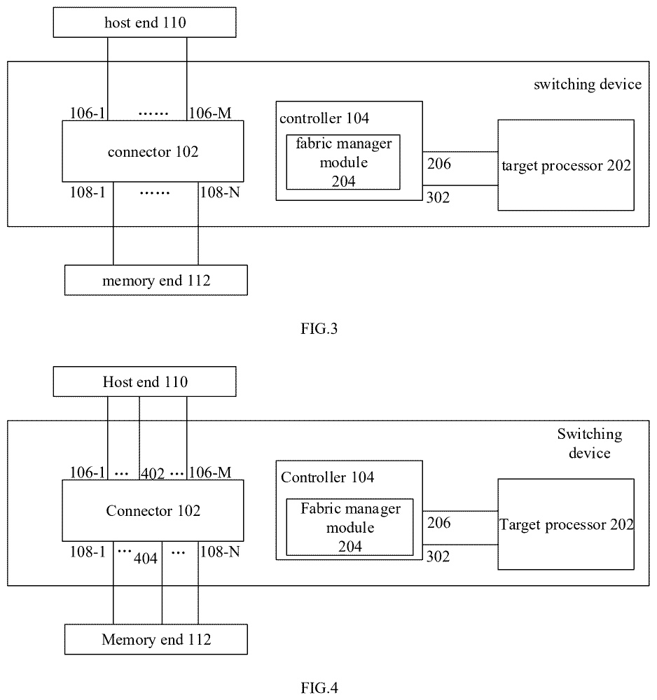

In an exemplary embodiment, FIG. 3 is a schematic diagram three of a switching device according to an embodiment of the present disclosure. As shown in FIG. 3, a universal asynchronous transceiver interface 302 is deployed on both the target processor 202 and the controller 104, wherein the target processor 202 is configured to write control signals and mapping relationships with corresponding relationships into the controller at the initialization stage of the switching device.

Optionally, in this embodiment, a UART (Universal Asynchronous Receiver/Transmitter) interface is deployed on both the target processor and the controller. In the initialization stage of the switching device, it is, but not limited to, receiving the signals sent by the target processor through the UART interface, to configure the types of the uplink and downlink ports of the switching device. For example, the target processor writes the control signal and the mapping relationship with corresponding relationship into the controller, so that the controller receives and stores the corresponding relationship between the control signal and the mapping relationship, wherein the mapping relationship includes the corresponding relationship between the uplink port and the downlink port.

In an exemplary embodiment, FIG. 4 is a schematic diagram four of a switching device according to an embodiment of the present disclosure. As shown in FIG. 4, the target uplink port 402 includes m uplink ports and the target downlink port 404 includes n downlink ports, where m is less than or equal to M and n is less than or equal to N.

Optionally, in this embodiment, it is, but not limited to, determining one or more uplink ports as target uplink ports. Each target uplink port may have one or more corresponding target downlink ports, and the number of target downlink ports of each target uplink port may, but is not limited to, be determined according to the requirement of the host connected to the target uplink port for extended memory, for example:

the uplink port includes uplink port 1, uplink port 2 and uplink port 3, and the downlink port includes downlink port 1, downlink port 2 and downlink port 3, the target downlink port of the target uplink port may include but is not limited to the following situations.

Under the condition that the uplink port 1 is determined as the target uplink port, the target downlink port corresponding to the uplink port 1 includes the downlink port 1; Alternatively, the target downlink port corresponding to uplink port 1 includes the downlink port 1 and the downlink port 2.

Under the condition that the uplink port 1 and the uplink port 2 are determined as the target uplink ports, the target downlink port corresponding to the uplink port 1 includes the downlink port 1, and the target downlink port corresponding to the uplink port 2 includes the downlink port 2. Alternatively, the target downlink port corresponding to the uplink port 1 includes the downlink port 1 and the downlink port 2 (the host end connected to the uplink port 1 needs more extended memory, so more extended memory is connected), and the target downlink port corresponding to the uplink port 2 includes the downlink port 3.

Optionally, in this embodiment, the target processor sends different control signals to the in-band configuration port of the switching device, and the in-band management port forwards the control signals to the fabric manager module. After the fabric manager module receives the control signals, the fabric manager module controls the target uplink port and the target downlink port to map according to the control signals. For example, the uplink port USP includes USP-0, USP-1, USP-2 and USP-3, and the downlink port (DSP) includes DSP-0 and DSP-1. Table 1 is an example of the mapping relationship among control signals, uplink ports and downlink ports, and the target mapping relationship indicated by the target control signal may include but is not limited to the following contents.

TABLE 1

| | |
|---|---|
| control signal | mapping relationship |

| | | |
|---|---|---|
| 0000 | DSP-0 | USP-0 |
| | DSP-1 | USP-0 |
| 0001 | DSP-0 | USP-0 |
| | DSP-1 | USP-1 |
| 0010 | DSP-0 | USP-0 |
| | DSP-1 | USP-2 |
| 0011 | DSP-0 | USP-0 |
| | DSP-1 | USP-3 |
| 0100 | DSP-0 | USP-1 |
| | DSP-1 | USP-0 |
| 0101 | DSP-0 | USP-1 |
| | DSP-1 | USP-1 |
| 0110 | DSP-0 | USP-1 |
| | DSP-1 | USP-2 |
| 0111 | DSP-0 | USP-1 |
| | DSP-1 | USP-3 |
| 1000 | DSP-0 | USP-2 |
| | DSP-1 | USP-0 |
| 1001 | DSP-0 | USP-2 |
| | DSP-1 | USP-1 |
| 1010 | DSP-0 | USP-2 |
| | DSP-1 | USP-2 |
| 1011 | DSP-0 | USP-2 |
| | DSP-1 | USP-3 |
| 1100 | DSP-0 | USP-3 |
| | DSP-1 | USP-0 |
| 1101 | DSP-0 | USP-3 |
| | DSP-1 | USP-1 |
| 1110 | DSP-0 | USP-3 |
| | DSP-1 | USP-2 |
| 1111 | DSP-0 | USP-3 |
| | DSP-1 | USP-3 |

As can be seen from Table 1, under the condition that the control signal includes 0000, the downlink port DSP-0 and the downlink port DSP-1 are taken as target downlink ports, and the memory end connected to the target downlink port is used to expand the memory for the target uplink port USP-0.

Under the condition that the control signal includes 0001, the downlink port DSP-0 is taken as the target downlink port of the uplink port USP-0, and the memory end connected to the target downlink port is used to expand the memory for the target uplink port USP-0; Take the downlink port DSP-1 as the target downlink port of the uplink port USP-1, and use the memory end connected to the target downlink port to expand the memory for the target uplink port USP-1.

Under the condition that the control signal includes 0010, the downlink port DSP-0 is taken as the target downlink port of the uplink port USP-0, and the memory end connected to the target downlink port is used to expand the memory for the target uplink port USP-0; Take the downlink port DSP-1 as the target downlink port of the uplink port USP-2, and use the memory end connected to the target downlink port to expand the memory for the target uplink port USP-2.

Under the condition that the control signal includes 0011, the downlink port DSP-0 is taken as the target downlink port of the uplink port USP-0, and the memory end connected to the target downlink port is used to expand the memory for the target uplink port USP-0; Take the downlink port DSP-1 as the target downlink port of the uplink port USP-3, and use the memory end connected to the target downlink port to expand the memory for the target uplink port USP-3.

Under the condition that the control signal includes 0100, the downlink port DSP-0 is taken as the target downlink port of the uplink port USP-1, and the memory end connected to the target downlink port is used to expand the memory for the target uplink port USP-1; Take the downlink port DSP-1 as the target downlink port of the uplink port USP-0, and use the memory end connected to the target downlink port to expand the memory for the target uplink port USP-0.

Under the condition that the control signal includes 0101, the downlink port DSP-0 is taken as the target downlink port of the uplink port USP-1, and the memory end connected to the target downlink port is used to expand the memory for the target uplink port USP-1; Take the downlink port DSP-1 as the target downlink port of the uplink port USP-1, and use the memory end connected to the target downlink port to expand the memory for the target uplink port USP-1.

Under the condition that the control signal includes 0110, the downlink port DSP-0 is taken as the target downlink port of the uplink port USP-1, and the memory end connected to the target downlink port is used to expand the memory for the target uplink port USP-1; Take the downlink port DSP-1 as the target downlink port of the uplink port USP-2, and use the memory end connected to the target downlink port to expand the memory for the target uplink port USP-2.

Under the condition that the control signal includes 0111, the downlink port DSP-0 is taken as the target downlink port of the uplink port USP-1, and the memory end connected to the target downlink port is used to expand the memory for the target uplink port USP-1; Take the downlink port DSP-1 as the target downlink port of the uplink port USP-3, and use the memory end connected to the target downlink port to expand the memory for the target uplink port USP-3.

Similarly, the target mapping relationships indicated by other target control signals included in Table 1 are similar to those described above, and are not repeated here.

The target control signals may include, but are not limited to, one or more control signals in Table 1. In the case that the target control signals include multiple control signals, the fabric manager module may, but is not limited to, map multiple target uplink ports to corresponding target downlink ports according to each of the target control signals.

In an exemplary embodiment, FIG. 5 is a schematic diagram five of a switching device according to an embodiment of the present disclosure. As shown in FIG. 5, M uplink ports (106-1 to 106-M) include a first uplink port 502, a second uplink port 504, a third uplink port 506 and a fourth uplink port 508, and the host end 110 includes a first processor 510 and a second processor 512, wherein the first uplink port and second uplink port are both connected to the first processor, the third uplink port and fourth uplink port are both connected to the second processor.

Optionally, in this embodiment, the first processor and the second processor can be a server respectively, but not limited to, or the first processor and the second processor are connected through a UPI bus to form a dual-path server as the host. In the case that the first processor and the second processor are connected through the UPI bus to form a dual-path server as the host, when the first processor obtains expanded memory, the second processor may, but is not limited to, access the expanded memory of the first processor through the UPI bus.

Optionally, in this embodiment, the first uplink port and the second uplink port are both connected to the first processor, and the third uplink port and the fourth uplink port are both connected to the second processor. The controller may, but not limited to, expand the memory for the first processor and the second processor by connecting the first uplink port, the second uplink port, the third uplink port and the fourth uplink port.

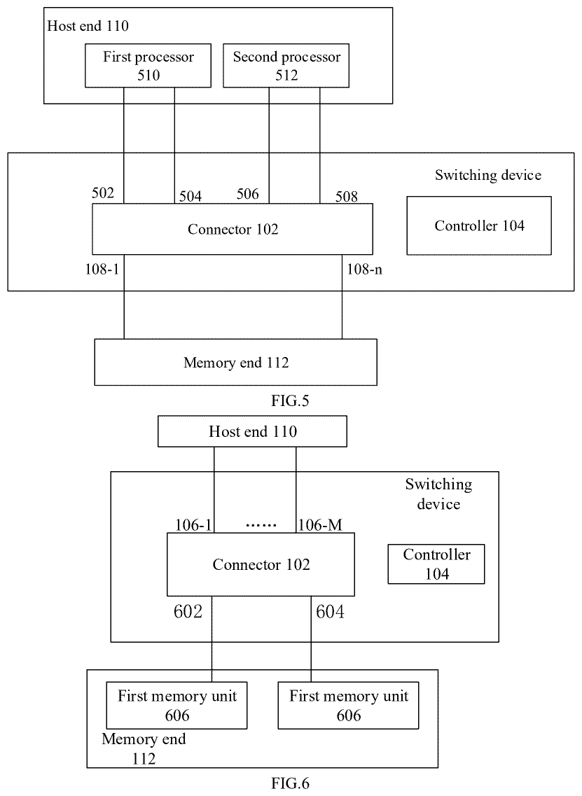

In an exemplary embodiment, FIG. 6 is a schematic diagram six of a switching device according to an embodiment of the present disclosure. As shown in FIG. 6, N downlink ports (108-1 to 108-N) include a first downlink port 602 and a second downlink port 604, and the memory end 112 includes a first memory unit 606 and a second memory unit 608, wherein the first downlink port 602 connects to the memory expansion controller in the first memory unit 606, and the second downlink port 604 connects to the memory expansion controller in the second memory unit 608.

Optionally, in this embodiment, the first downlink port is connected to the memory expansion controller in the first memory unit, and the second downlink port is connected to the memory expansion controller in the second memory unit, and the memory expansion controller expands the memory through an internal DDR (Double Data Rate) controller.

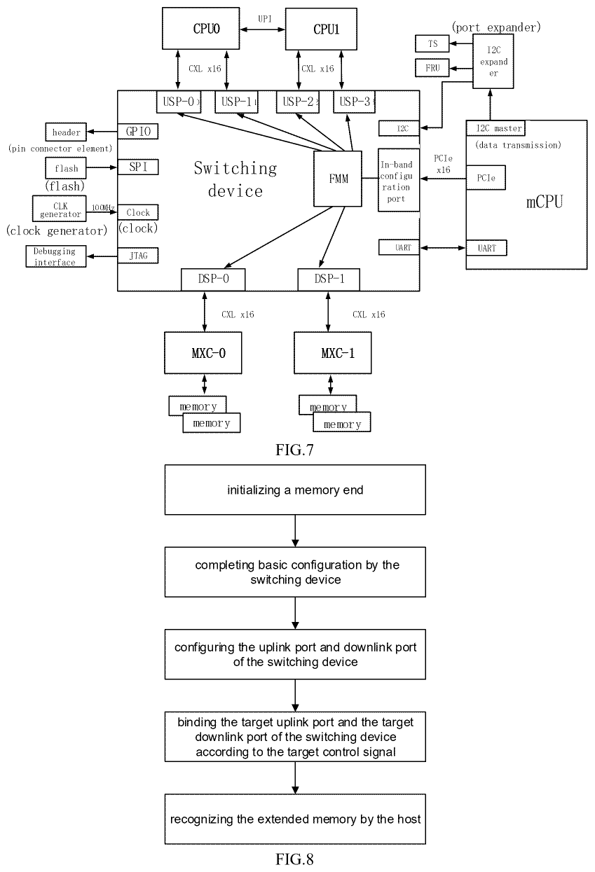

In an exemplary embodiment, FIG. 7 is a schematic diagram of a use process of a switching device according to an embodiment of the present disclosure. As shown in FIG. 7, the switching device includes a Fabric Manager Module (FMM), and the fabric manager module is connected to an in-band configuration port, and the in-band configuration port is connected to a target processor (mCPU) through a set of PCIe x16 buses, and forwards the target control signal sent by the target processor to the fabric manager module. The fabric manager module is also connected to a plurality of uplink ports and downlink ports, wherein the uplink ports include USP-0, USP-1, USP-2 and USP-3, and the downlink ports include DSP-0 and DSP-1; under the control of the target control signal sent by mCPU, the fabric manager module obtains the mapping between the target uplink port and the target downlink port. The CXL bus supporting a single host is connected to different target downlink ports, thereby expanding a larger memory for the host end connected to the target uplink port, wherein the corresponding relationship between the uplink port and the downlink port and the control signal is written into the fabric manager module by the target processor through UART at the initialization stage of the switching device.

The uplink port of the switching device is connected to the host end through the CXL protocol, and the host end includes CPU0 and CPU1, and the CPU0 and CPU1 are interconnected through a UPI bus to form a dual-path server as the host end. When one CPU expands its memory, the other CPU can obtain the expanded memory through the UPI bus, and each CPU can provide two sets of CXL x16 interfaces, which are respectively connected to the uplink port of the switching device.

The downlink port of the switching device is connected to the MXC at the memory end through the CXL protocol, and the memory is expanded through the DDR controller inside the MXC.

For the switching device, it also includes a GPIO (General-purpose input/output) as a debugging interface. The GPIO can output the status information of internal ports, such as PLL status (Phase Locked Loop), Boot done (Bootstrap done) and Link up. When the switching device has problems, it can check the port status through the GPIO to help locate the problem point. For example as following.

PLL status: when a level is 1, it indicates that a clock frequency and phase of the PLL are stable; When the level is 0, it indicates that the PLL is not stable.

Boot done: when a level is 1, it indicates that a port is initialized; When the level is 0, it indicates that the initialization of the port has not been completed.

Link up: when a level is 1, it indicates that a port has completed a connection with a host or a memory; When the level is 0, it indicates no connection or connection failure.

Similarly, the switching device also supports the debugging of JTAG (Joint Test Action Group) interface, and uses JTAG debugger to connect to the switching device to debug the register of the device.

Using a Flash to store the firmware information of the switching device. After the switching device is powered on, the switching device can read the firmware configuration information of the switching device through a SPI bus to complete the basic initialization configuration.

Using CLK Generator (clock generator) to output 100 MHz clock to the switching device, to provide basic clock requirements.

In addition, the switching device also includes the topological connection of I2C (Inter-Integrated circuit, a two-wire serial bidirectional bus) interface. For example, a mCPU, as the host end of an I2C, expands the port through an I2C expander and connects to a TS (Thermal Sensor) to read the temperature of the switching device in real time. Connect to a FRU (Field Replaceable Unit) to obtain basic board information such as the manufacturer, production date and firmware version of the switching device. The I2C connected to the switching device supports reading the register information of the switching device.

In an exemplary embodiment, FIG. 8 is a schematic diagram of a memory expansion process of a switching device according to the embodiment of the present disclosure. As shown in FIG. 8, Under the condition that the memory end completes the initialization work, the switching device reads firmware information and performs basic configuration, and the target processor communicates with the universal asynchronous transceiver interface through the PCIe x16 bus to configure the uplink port and downlink port of the switching device. In the process of memory expansion using the switching device, the fabric manager module deployed in the switching device receives the target control signal sent by the target processor, and binds the target uplink port and the target downlink port of the switching device according to the target control signal, so that the host connected to the target uplink port can recognize the extended memory connected to the target downlink port, thereby completing the expansion of the memory.

In this embodiment, a memory expansion module is also provided. The memory expansion module is configured to realize the above-mentioned embodiments and alternative implementation, and the description is not repeated here. As used below, the term “unit” may be a combination of software and/or hardware that implements a predetermined function. Although the memory expansion module described in the following embodiments is preferably implemented in software, the implementation of hardware, or a combination of software and hardware, is also possible and contemplated.

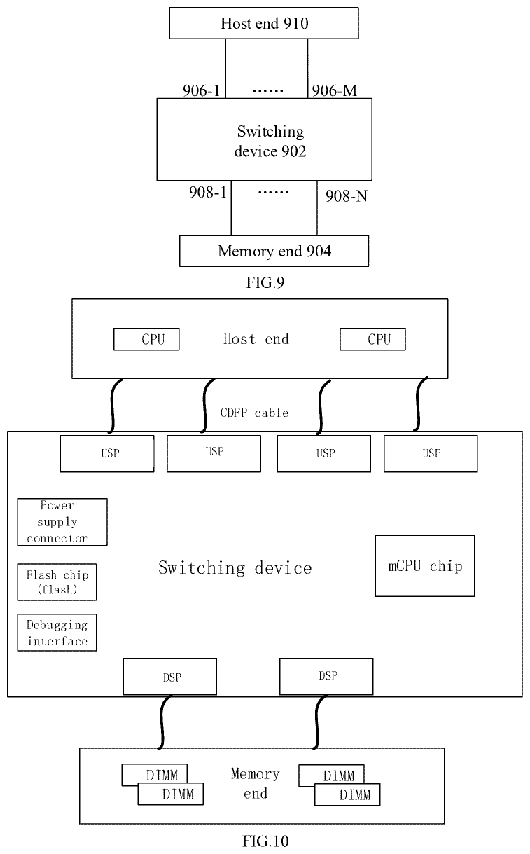

FIG. 9 is a schematic diagram of a memory expansion module according to an embodiment of the present disclosure. As shown in FIG. 9, the memory expansion module includes a switching device 902 and a memory end 904, wherein M uplink ports (906-1 to 906-M) and N downlink ports (908-1 to 908-N) are deployed on the switching device 902. N downlink ports (908-1 to 908-N) are connected to the memory end 904 through the CXL protocol, wherein M is an integer greater than or equal to 1 and N is an integer greater than 1. M uplink ports, are configured to connect to the host end 910 by the CXL protocol; A switching device 902, is configured to control the binding between the M uplink ports (906-1 to 906-M) and the N downlink ports (908-1 to 908-N), wherein each uplink port is allowed to be mapped to the N downlink ports (908-1 to 908-N); The memory end 904 is configured to provide extended memory for the host end 910.

According to the memory expansion module, the M uplink ports deployed on the connector are connected to the host ends through the CXL (Compute Express Link) protocol, and the N downlink ports deployed on the connector are connected to the memory ends through the CXL protocol. As the controller realizes the binding between the M uplink ports and the N downlink ports, each host end connected to the uplink ports can use the extended memory connected to the downlink ports which have a mapping relationship with it, to expand the memory for one or more host ends. Therefore, the problem of low memory capacity can be solved, and the effect of expanding the memory capacity can be achieved.

In one exemplary embodiment, the switching device includes a connector and a controller, wherein, the connector is deployed with the M uplink ports and the N downlink ports; the controller is configured to obtain a target mapping relationship between a target uplink port and a target downlink port; bind the target uplink port and the target downlink port according to the target mapping relationship.

In one exemplary embodiment, the switching device further includes a target processor, wherein, the controller includes a fabric manager module and an in-band configuration port; the target processor is configured to send a target control signal to the fabric manager module through the in-band configuration port; the fabric manager module is configured to find the target mapping relationship corresponding to the target control signal from the control signals and mapping relationships with corresponding relationships and bind the target uplink port and the target downlink port according to the target mapping relationship.

In one exemplary embodiment, both the target processor and the controller are deployed with universal asynchronous transceiver interfaces, wherein, the target processor is configured to write the control signals and the mapping relationships with corresponding relationships into the controller at an initialization stage of the switching device.

In one exemplary embodiment, the target uplink port includes m uplink ports and the target downlink port includes n downlink ports, wherein m is less than or equal to M and n is less than or equal to N.

In one exemplary embodiment, the M uplink ports include a first uplink port, a second uplink port, a third uplink port and a fourth uplink port, and the host end includes a first processor and a second processor, wherein, the first uplink port and the second uplink port are both connected to the first processor, and the third uplink port and the fourth uplink port are both connected to the second processor.

In one exemplary embodiment, the N downlink ports include a first downlink port and a second downlink port, and the memory end includes a first memory unit and a second memory unit, wherein, the first downlink port is connected to a memory expansion controller in the first memory unit, and the second downlink port is connected to a memory expansion controller in the second memory unit.

In an exemplary embodiment, FIG. 10 is a schematic diagram of an expanded memory of a memory expansion module according to an embodiment of the present disclosure. As shown in FIG. 10, an uplink port USP is deployed on a switching device, which is connected to a host end through a CDFP (Compact Digital Format Pluggable) cable of CXL x16, and the host end includes a plurality of CPUs. A downlink port DSP is also deployed on the switching device, which is connected to a memory end through the CDFP cable of CXL x16, and the memory end includes a plurality of DIMM memory modules.

The memory expansion module also includes a power connector, a flash memory device and a debugging interface, wherein the power connector can support the power input of P12V and P3V3_AUX, and the debugging interface is convenient for debugging the memory expansion module.

In this embodiment, a memory expansion system is also provided, which is used to realize the above-mentioned embodiments and alternative implementation, and the description is not repeated here. As used below, the term “unit” may be a combination of software and/or hardware that implements a predetermined function. Although the memory expansion system described in the following embodiments is preferably implemented in software, the implementation of hardware, or a combination of software and hardware, is also possible and contemplated.

FIG. 11 is a schematic diagram of a memory expansion system according to an embodiment of the present disclosure. As shown in FIG. 11, the memory expansion system includes a host end 1102, a switching device 1104 and a memory end 1106, wherein M uplink ports (1108-1 to 1108-M) and N downlink ports (1110-1 to 1110-M) are deployed on the switching device 1104.

The N downlink ports (1110-1 to 1110-N) are connected to the memory end 1106 through the CXL protocol, and the M uplink ports (1108-1 to 1108-M) are connected to the host end 1102 through the CXL protocol, where M is an integer greater than or equal to 1 and N is an integer greater than 1; A switching device 1104 is configured to control the binding between the M uplink ports (1108-1 to 1108-M) and the N downlink ports (1110-1 to 1110-N), wherein each uplink port is allowed to be mapped to N downlink ports; A memory end 1106 is configured to provide extended memory for the host end 1102; The host end 1102 is configured to use the memory end 1106 as extended memory.

According to the memory expansion system, the M uplink ports deployed on the connector are connected to the host ends through the CXL (Compute Express Link) protocol, and the N downlink ports deployed on the connector are connected to the memory ends through the CXL protocol. As the controller realizes the binding between the M uplink ports and the N downlink ports, each host end connected to the uplink ports can use the extended memory connected to the downlink ports which have a mapping relationship with it, to expand the memory for one or more host ends. Therefore, the problem of low memory capacity can be solved, and the effect of expanding the memory capacity can be achieved.

In one exemplary embodiment, the switching device includes a connector and a controller, wherein, the connector is deployed with the M uplink ports and the N downlink ports; the controller is configured to obtain a target mapping relationship between a target uplink port and a target downlink port; bind the target uplink port and the target downlink port according to the target mapping relationship.

In one exemplary embodiment, the switching device further includes a target processor, wherein, the controller includes a fabric manager module and an in-band configuration port; the target processor is configured to send a target control signal to the fabric manager module through the in-band configuration port; the fabric manager module is configured to find the target mapping relationship corresponding to the target control signal from the control signals and mapping relationships with corresponding relationships and bind the target uplink port and the target downlink port according to the target mapping relationship.

In one exemplary embodiment, both the target processor and the controller are deployed with universal asynchronous transceiver interfaces, wherein, the target processor is configured to write the control signals and the mapping relationships with corresponding relationships into the controller at an initialization stage of the switching device.

In one exemplary embodiment, the target uplink port includes m uplink ports and the target downlink port includes n downlink ports, wherein m is less than or equal to M and n is less than or equal to N.

In one exemplary embodiment, the M uplink ports include a first uplink port, a second uplink port, a third uplink port and a fourth uplink port, and the host end includes a first processor and a second processor, wherein, the first uplink port and the second uplink port are both connected to the first processor, and the third uplink port and the fourth uplink port are both connected to the second processor.

In one exemplary embodiment, the N downlink ports include a first downlink port and a second downlink port, and the memory end includes a first memory unit and a second memory unit, wherein, the first downlink port is connected to a memory expansion controller in the first memory unit, and the second downlink port is connected to a memory expansion controller in the second memory unit.

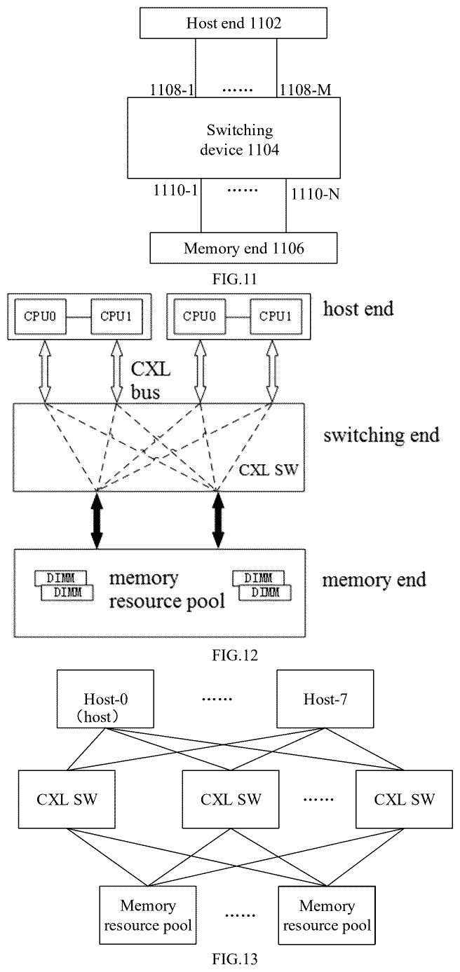

In an exemplary embodiment, FIG. 12 is a schematic diagram of expanded memory of a memory expansion system according to an embodiment of the present disclosure. As shown in FIG. 12, the memory expansion system includes a host end, a switching terminal (switching device) and a memory end. The CPU0 and CPU1 on the host end form a dual-path server, which is interconnected to the input interface (uplink port) of a CXL SW (switching device) through a CXL bus. The CXL SW supports multi-host connection, and the output interface of the CXL SW is interconnected to the memory resource pool (memory end). All input interfaces (downlink ports) of the CXL SW support connection to each output interface. In this way, each CXL bus of CPU may expand more memory to greatly improve the system memory capacity and maximize the resource utility of the CXL ports.

In an exemplary embodiment, FIG. 13 is a schematic diagram of the expanded memory of a large-scale memory expansion system according to an embodiment of the present disclosure. As shown in FIG. 13, the memory expansion system includes a plurality of hosts (for example, hosts include Host0 to Host7), and each host can be connected to a plurality of switching devices (CXL SW), and the number of memory resource pools at the memory end can also be increased accordingly, thus realizing the super-large capacity expansion of multi-hosts, multi-switching devices and multi-memory resource pools.

Optional examples in this embodiment can refer to the examples described in the above-mentioned embodiments and exemplary implementations, and this embodiment is not repeated here.

Apparently, those skilled in the art should understand that the above-mentioned modules or steps of the present disclosure can be realized by general computing devices, they can be concentrated on a single computing device or distributed on a network composed of multiple computing devices, and they can be realized by program codes executable by computing devices, so that they can be stored in storage devices and executed by computing devices, and in some cases, The steps shown or described may be performed in a different order from here, or they may be made into individual integrated circuit modules, or a plurality of them or steps may be made into a single integrated circuit module. As such, the present disclosure is not limited to any particular combination of hardware and software.

The above are only alternative embodiments of the present disclosure, and they are not used to limit the present disclosure. For those skilled in the art, the present disclosure can be modified and varied. Any modification, equivalent substitution, improvement, etc. made within the principles of the present disclosure shall be included in the protection scope of the present disclosure.

1. A switching device comprising a connector and a controller, wherein,
the connector is deployed with M uplink ports and N downlink ports, wherein M is an integer greater than or equal to 1 and N is an integer greater than 1;
the M uplink ports are configured to connect to a host end by a CXL (Compute Express Link) protocol;
the N downlink ports are configured to connect to a memory end by the CXL protocol, wherein the memory end is an extended memory of the host end;
the controller is configured to control a binding between the M uplink ports and the N downlink ports, wherein each uplink port is allowed to be mapped to the N downlink ports.

2. The switching device according to claim 1, wherein the controller is configured to:
acquire a target mapping relationship between a target uplink port and a target downlink port;
bind the target uplink port and the target downlink port according to the target mapping relationship.

3. The switching device according to claim 2, wherein the switching device further comprises a target processor, wherein,
the controller comprises a fabric manager module and an in-band configuration port;
the target processor is configured to send a target control signal to the fabric manager module through the in-band configuration port;
the fabric manager module is configured to find the target mapping relationship corresponding to the target control signal from the control signals and mapping relationships with corresponding relationships and bind the target uplink port and the target downlink port according to the target mapping relationship.

4. The switching device according to claim 3, wherein both the target processor and the controller are deployed with universal asynchronous transceiver interfaces, wherein,
the target processor is configured to write the control signals and the mapping relationships with corresponding relationships into the controller at an initialization stage of the switching device.

5. The switching device according to claim 1, wherein,
both the target processor and the controller are deployed with universal asynchronous transceiver interfaces, and in the initialization stage of the switching device, the controller receives signals sent by the target processor through the universal asynchronous transceiver interfaces, to configure types of the uplink ports and downlink ports of the switching device; the target processor writes the control signals and the mapping relationships with corresponding relationships into the controller through the universal asynchronous transceiver interface, and the controller receives and stores the corresponding relationships between the control signals and the mapping relationships, wherein the mapping relationships comprise the corresponding relationships between the uplink ports and the downlink ports.

6. The switching device according to claim 2, wherein the target uplink port comprises m uplink ports and the target downlink port comprises n downlink ports, wherein m is less than or equal to M and n is less than or equal to N.

7. The switching device according to claim 1, wherein the M uplink ports comprise a first uplink port, a second uplink port, a third uplink port and a fourth uplink port, and the host end comprises a first processor and a second processor, wherein,
the first uplink port and the second uplink port are both connected to the first processor, and the third uplink port and the fourth uplink port are both connected to the second processor.

8. The switching device according to claim 1, wherein the N downlink ports comprise a first downlink port and a second downlink port, and the memory end comprises a first memory unit and a second memory unit, wherein,
the first downlink port is connected to a memory expansion controller in the first memory unit, and the second downlink port is connected to a memory expansion controller in the second memory unit.

9. The switching device according to claim 1, wherein,
the uplink port of the switching device is connected to the host end through the CXL protocol, and the host end comprises a processor 0 and a processor 1, and the processor 0 and the processor 1 are interconnected through a UPI (Ultra Path Interconnect) bus to form a dual-path server as the host end, in response to that one processor performs memory expansion, the other processor obtains a expanded memory through the UPI (Ultra Path Interconnect) bus, and each processor provides two sets of CXL x16 interfaces, which are respectively connected to the uplink port of the switching device; the downlink port of the switching device is connected to the memory expansion controller at the memory end through the CXL protocol, enabling the memory expansion by a double-rate controller inside the memory expansion controller.

10. A memory expansion module, comprising a switching device and a memory end, wherein,
the switching device is deployed with M uplink ports and N downlink ports, and the N downlink ports are connected to the memory end through a CXL (Compute Express Link) protocol, wherein M is an integer greater than or equal to 1, and N is an integer greater than 1;
the M uplink ports are configured to connect to the host end by the CXL protocol;
the switching device is configured to control a binding between the M uplink ports and the N downlink ports, wherein each uplink port is allowed to be mapped to the N downlink ports;
the memory end is configured to provide extended memory for the host end.

11. The memory expansion module according to claim 10, wherein the switching device comprises a connector and a controller, wherein,
the connector is deployed with the M uplink ports and the N downlink ports;
the controller is configured to obtain a target mapping relationship between a target uplink port and a target downlink port; bind the target uplink port and the target downlink port according to the target mapping relationship.

12. The memory expansion module according to claim 11, wherein the switching device further comprises a target processor, wherein,
the controller comprises a fabric manager module and an in-band configuration port;
the target processor is configured to send a target control signal to the fabric manager module through the in-band configuration port;
the fabric manager module is configured to find the target mapping relationship corresponding to the target control signal from the control signals and mapping relationships with corresponding relationships and bind the target uplink port and the target downlink port according to the target mapping relationship.

13. The memory expansion module according to claim 12, wherein both the target processor and the controller are deployed with universal asynchronous transceiver interfaces, wherein,
the target processor is configured to write the control signals and the mapping relationships with corresponding relationships into the controller at an initialization stage of the switching device.

14. The memory expansion module according to claim 11, wherein the target uplink port comprises m uplink ports and the target downlink port comprises n downlink ports, wherein m is less than or equal to M and n is less than or equal to N.

15. The memory expansion module according to claim 10, wherein the M uplink ports comprise a first uplink port, a second uplink port, a third uplink port and a fourth uplink port, and the host end comprises a first processor and a second processor, wherein,
the first uplink port and the second uplink port are both connected to the first processor, and the third uplink port and the fourth uplink port are both connected to the second processor.

16. The memory expansion module according to claim 10, wherein the N downlink ports comprise a first downlink port and a second downlink port, and the memory end comprises a first memory unit and a second memory unit, wherein,
the first downlink port is connected to a memory expansion controller in the first memory unit, and the second downlink port is connected to a memory expansion controller in the second memory unit.

17. A memory expansion system, comprising a host end, a switching device and a memory end, wherein,
the switching device is deployed with M uplink ports and N downlink ports, wherein the N downlink ports are connected to the memory end through a CXL (Compute Express Link) protocol, and the M uplink ports are connected to the host end through the CXL protocol, wherein M is an integer greater than or equal to 1, and N is an integer greater than 1;
the switching device is configured to control a binding between the M uplink ports and the N downlink ports, wherein each uplink port is allowed to be mapped to the N downlink ports;
the memory end is configured to provide an extended memory for the host end;
the host end is configured to use the memory end as the extended memory.

18. The memory expansion system according to claim 17, wherein the switching device comprises a connector and a controller, wherein,
the connector is deployed with the M uplink ports and the N downlink ports;
the controller is configured to obtain a target mapping relationship between a target uplink port and a target downlink port; bind the target uplink port and the target downlink port according to the target mapping relationship.

19. The memory expansion system according to claim 18, wherein the switching device further comprises a target processor, wherein,
the controller comprises a fabric manager module and an in-band configuration port;
the target processor is configured to send a target control signal to the fabric manager module through the in-band configuration port;
the fabric manager module is configured to find the target mapping relationship corresponding to the target control signal from the control signals and mapping relationships with corresponding relationships and bind the target uplink port and the target downlink port according to the target mapping relationship.

20. The memory expansion system according to claim 19, wherein both the target processor and the controller are deployed with universal asynchronous transceiver interfaces, wherein,
the target processor is configured to write the control signals and the mapping relationships with corresponding relationships into the controller at an initialization stage of the switching device.

21-23. (canceled)
